(19) United States
(12) Patent Application Publication
(10) Pub. No.: US 2007/0157284 A1
(43) Pub. Date: Jul. 5, 2007

(54) Caption display method and device in content retrieval on A/V network supporting web service technologies

(75) Inventors: Jong-rip Lee, Bucheon-si (KR); Seok-cheon Kang, Seoul (KR); Si-cheol Kim, Seoul (KR); Han-chul Ahn, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/541,552

(22) Filed: Oct. 3, 2006

(30) Foreign Application Priority Data
Jan. 5, 2006 (KR) 2006-0001499

(51) Int. Cl. H04N 7/08

(52) U.S. Cl. 725/137

(57) ABSTRACT

Disclosed is a caption display method and device in contents retrieval on an A/V network supporting web service technologies. A caption display method in contents retrieval on an A/V network comprises searching for captions corresponding to contents selected for retrieval, and loading the searched captions; parsing the loaded captions; decoding the parsed captions and the contents selected for retrieval; and encoding contents containing the decoded captions into a retrievable format. Thus, since the contents and the captions are simultaneously provided, user's convenience is enhanced.

### CROSS-REFERENCE TO RELATED APPLICATIONS

This application claims priority under 35 U.S.C. §119 from Korean Patent Application 2006-1499, filed on Jan. 5, 2006, the entire contents of which are incorporated herein by reference.

### BACKGROUND OF THE INVENTION

1. Field of the invention

The present invention relates to a caption display method and device in content retrieval, and more specifically, to a caption display method and device used in content retrieval, capable of displaying captions corresponding to contents when retrieving the contents by use of web services in A/V network supporting web service technologies.

2. Description of the Related Art

Recently, together with the remarkable advancements of digital audio/video (hereafter, referred to as A/V) processing technologies, various A/V devices, such as digital TVs, set-top boxes, DVD players, digital amplifiers, and so on, are installed and used at homes and offices. Users can conveniently control such devices using a remote controller, but as more A/V devices are installed in a certain space, the control of each device becomes more complicated and difficult.

Thus, studies have been undertaken on technologies interconnecting plural A/V devices into one system and enabling users to conveniently control the systemized A/V devices. According to such studies, A/V devices are connected to different A/V devices through a network interface so that one A/V network is formed as a whole.

As part of such studies, standards on the eXpandable Home Theater (XHT) technologies as being a middleware for A/V home networking have been developed and proposed. Such XHT technologies are a home network solution focusing on digital TVs developed by Samsung Electronics Co., Ltd., which has been adopted as a standard specification of the Consumer Electronics Association (CSA) of the United States America.

The XHT technologies allow users to control plural digital TVs as well as A/V devices connected to the digital TVs by the use of IEEE1394 cables. These cables are capable of stably transferring plural High Definition (HD) class signals and the Internet Protocol (IP) that is a communication specification mainly used for Internet. For example, with the XHT technologies, a user can watch digital broadcasts in a master bedroom by using the digital broadcast receiving functions of a digital TV placed in a living room.

Further, the XHT technologies can provide various forms of portal services such as multimedia contents retrieval through a browser embedded in a digital TV.

FIG. 1 is a view for showing a general A/V network system. In FIG. 1, a general A/V network system is formed with an Internet network 10 based on Ethernet and an IEEE1394 network 50 based on IEEE1394. In detail, there exists a PC 12, as an example, being an A/V device included in the Internet network 10 based on Ethernet, a digital television (DTV) 52 included in the IEEE1394 network 50 based on IEEE1394, and an A/V gateway 100 connecting the Internet network 10 to the IEEE1394 network 50.

The PC 12 provides various multimedia contents such as video, images, and sounds. The DTV 52 reproduces diverse multimedia contents provided by the PC 12 so that a user can watch the contents. The A/V gateway 100 connects the PC 12 to the DTV 52, and provides the DTV 52 with a contents list created by the use of information on contents provided in a form of web services and the contents selected by a user.

The contents the PC 12 provides have diverse formats such as MPEG2, AVI, DVIX, MP3, ASF, WMV, and the like, but, since the DTV 52 can retrieve only the contents of MPEG2—TS format, the A/V gateway 100 converts contents of diverse formats into the MPEG2—TS format and provides the converted contents.

However, in a general A/V network system, there is no method for displaying captions existing separately from the contents. That is, if captions exist separately from contents, the A/V gateway 100 provides only the contents. Further, even though the A/V gateway 100 provides captions, there is no method within which it can simultaneously display the captions and the contents provided to the DTV 52.

Accordingly, a user cannot be provided with caption services, and thus, cannot properly grasp the nature of the contents, which causes user's inconvenience more.

### SUMMARY OF THE INVENTION

The present invention has been developed in order to address the above drawbacks and other problems associated with the conventional arrangement. An aspect of the present invention is to provide a caption display method and device in contents retrieval on an A/V network supporting web service technologies, capable of simultaneously displaying contents and captions corresponding to the contents when the contents provided on the internet network based on Ethernet are retrieved on the IEEE1394 network.

The foregoing and other aspects are substantially realized by providing a caption display method in contents retrieval on an A/V network, comprising searching for captions corresponding to contents selected for retrieval, and loading the searched captions; parsing the loaded captions; decoding the parsed captions and the contents selected for retrieval; and encoding contents containing the decoded captions into a retrievable format.

Additionally, according to an aspect of the present invention said decoding may include outputting the parsed caption data to the decoded contents for a caption display period at a corresponding caption display time.

Further, according to another aspect, parsing the loaded captions also includes separating caption data, caption display time, and caption display period contained in the loaded captions.

According to another aspect, the method further comprises sending contents containing the encoded captions based on IEEE1394.

Further, according to another aspect, encoding may include converting to an MPEG2—TS format and digitizing the caption-containing contents.

Meanwhile, according to another aspect of the present invention, a contents retrieval device comprises a caption loading unit for searching for captions corresponding to contents selected for retrieval and loading the searched captions; a caption parsing unit for parsing the loaded captions; a contents decoding unit for decoding the parsed captions and the contents selected for retrieval; and a contents encoding unit for encoding contents containing the decoded captions into a retrievable format.

According to another aspect, the contents decoding unit outputs the parsed caption data to the decoded contents for a caption display period at a corresponding caption display time.

According to another aspect, the caption parsing unit separates caption data, caption display time, and caption display period contained in the loaded captions.

According to another aspect, the device further comprises a contents transferring unit for sending contents containing the encoded captions based on IEEE1394.

According to another aspect, the contents encoding unit converts into an MPEG2—TS format and digitizes the caption-containing contents.

### BRIEF DESCRIPTION OF THE DRAWINGS

The above aspects and features of the present invention will be more apparent by describing certain illustrative non-limiting exemplary embodiments of the present invention with reference to the accompanying drawings, in which:

FIG. 1 is a view for showing a general A/V network system;

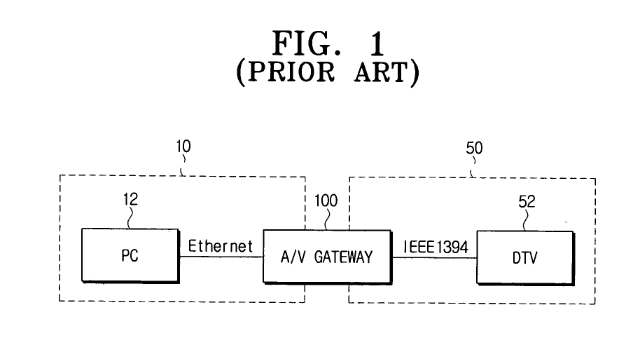

FIG. 2 is a block diagram for showing an A/V gateway according to an exemplary embodiment of the present invention; and

FIG. 3 is a flow chart for explaining a caption display method upon contents retrieval of the A/V gateway according to an exemplary embodiment of the present invention.

### DETAILED DESCRIPTION OF THE EXEMPLARY EMBODIMENTS

Hereinafter, the features and aspects of the present invention will be described in detail with reference to the accompanying drawings.

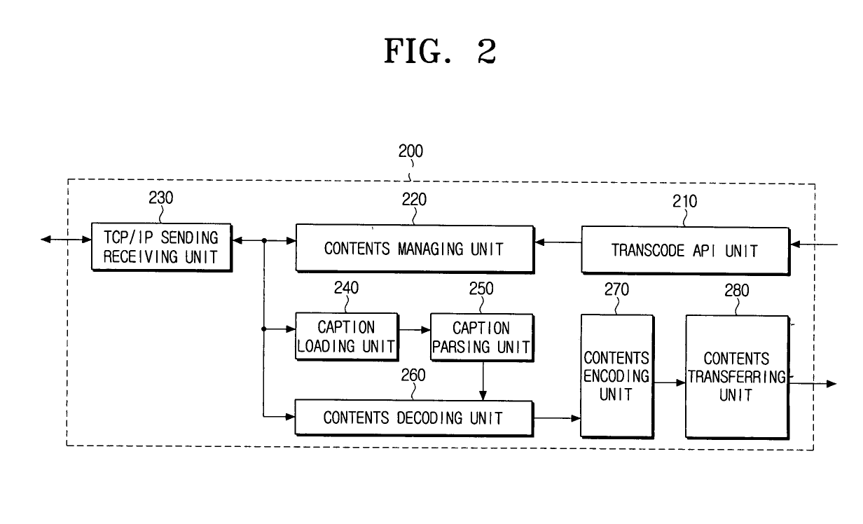

FIG. 2 is a block diagram for showing an A/V gateway according to an exemplary embodiment of the present invention.

The A/V gateway 200 retrieves and provides captions corresponding to contents at the same time contents are retrieved when contents are provided on an Ethernet-based Internet network to an A/V device included in an IEEE1394 network. the AN gateway 200 can be separately provided, or can be any of a diverse number of A/V devices such as a digital TV, a set-top box, a DVD player, a digital amplifier, and so on.

In FIG. 2, the A/V gateway 200 includes a transcode Application Program Interface (API) unit 210, a contents managing unit 220, a TCP/IP sending/receiving unit 230, a contents decoding unit 260, a caption loading unit 240, a caption parsing unit 250, a contents encoding unit 270, and a contents transferring unit 280.

The transcode API unit 210 receives a user's command such as a contents list request command, contents selection command, contents playback command, and so on, through the DTV 52.

The contents managing unit 220 creates a contents list by using information on contents provided from the PC 12 if it receives a contents list request command from the transcode API unit 210.

The Transport Control Protocol/Internet Protocol (TCP/IP) sending/receiving unit 230 provides an interface for communicating with the PC 12 included in the Internet network. That is, the TCP/IP sending/receiving unit 230 sends a contents list request command to the PC 12, and receives information on contents from the PC 12. Further, the TCP/IP sending/receiving unit 230 receives contents and captions corresponding to contents from the PC 12 according to a contents selection command or a contents playback command.

The caption loading unit 240 searches for captions of the contents selected by the PC 12 if a contents selection command is inputted. Then, the caption loading unit 240 loads the searched captions corresponding to selected contents.

The caption parsing unit 250 parses the loaded caption. In detail, the caption parsing unit 250 separates a caption display time, caption display period, and caption data which are contained in the captions.

The contents decoding unit 260 decodes the contents received through the TCP/IP sending/receiving unit 230 if a contents selection command or a contents retrieval command is inputted. Additionally, the contents decoding unit 260 outputs caption data parsed by the caption parsing unit 250 to the decoded contents during the caption display period at the caption display time corresponding to the caption data.

The contents encoding unit 270 encodes the contents decoded by the contents decoding unit 260. In detail, the contents encoding unit 270 converts the contents including the caption data into Moving Picture Experts Group—Transport Stream (MPEG2—TS) format that the DTV 52 can retrieve, and digitizes the MPEG2—TS format.

The contents transferring unit 280 transfers the contents encoded by the contents encoding unit 270 to the DTV 52. In particular, the contents transferring unit 280 transfers the caption-containing contents based on IEEE1394.

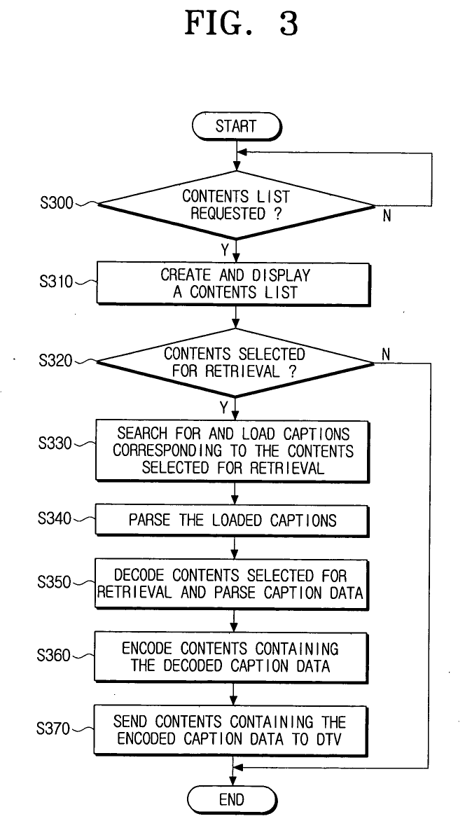

FIG. 3 is a flow chart for explaining a caption display method of contents retrieval of the A/V gateway according to an exemplary embodiment of the present invention.

In FIG. 3, the contents managing unit 220 decides whether or not a contents list request command is inputted (S300). The contents list request command is inputted by a user from the DTV 52 through the transcode API 210.

If the contents list request command is inputted (S300-Y), the contents managing unit 220 creates a contents list and displays the contents list on the DTV 52 (S310). The contents list is converted into the MPEG2—TS format by the contents encoding unit 270 and sent to the DTV 52 through the contents transferring unit 280.

The caption loading unit 240 decides whether or not a contents selection command and a contents retrieval command are inputted (S320). The contents selection command and the contents retrieval command are inputted by a user from the DTV 52 through the transcode API 210.

If the contents selection command and the contents retrieval command are inputted (S320-Y), the caption loading unit 240 searches for captions corresponding to the contents selected for retrieval, and loads the searched corresponding captions (S330). If the captions of the contents selected for retrieval is not searched for, the caption loading unit 240 can create and display a message stating that captions do not exist.

The caption parsing unit 250 parses the loaded captions (S340). The captions display is displayed during the display period at the time for the captions corresponding to the contents to be displayed. For example, caption data of “caption display” may be displayed for 30 seconds in 5 minutes from after the contents retrieval time of 0. For this purpose, captions contain caption data, a caption display time, and a caption display period, and the caption parsing unit 250 separates them from each other.

The contents decoding unit 260 decodes the contents selected for retrieval and the parsed caption data (S350). If there exist caption data to be displayed at a caption display time consistent with a contents output time, the contents decoding unit 260 creates bitmap images of the caption data, and outputs the created caption images together with the decoded contents for the caption display period at the same time.

The contents encoder 270 encodes the contents containing the caption data decoded by the contents decoder 260 (S360).

Further, the contents transferring unit 280 transfers to the DTV 52 the caption data-containing contents encoded by the contents encoding unit 270 (S370).

By doing so, a user can be provided with services which can retrieve captions together with the contents that the user wants to watch.

As stated above, according to the exemplary embodiments of the present invention, since contents and captions are simultaneously provided, a user's convenience is enhanced.

Moreover, since diverse contents can be provided, the utility and use of the XHT devices are enhanced and contributions can be made to the activeness and business of the XHT standards.

As aforementioned, the exemplary embodiments of the present invention are shown and described for purposes of illustration, but the present invention is not limited to the specific embodiments described above, and can be implemented in various modifications by those skilled in the art to which the present invention pertains without departing the scope of the present invention claimed in the appended claims.

What is claimed is:

1. A caption display method in contents retrieval on an A/V network, comprising:
searching for captions corresponding to contents selected for retrieval, and loading the searched captions;
parsing the loaded captions;
decoding the parsed captions and the contents selected for retrieval; and
encoding contents containing the decoded captions into a retrievable format.

2. The method as claimed in claim 1, wherein said decoding includes outputting the parsed caption data to the decoded contents for a caption display period at a corresponding caption display time.

3. The method as claimed in claim 1, wherein said parsing the loaded captions includes separating caption data, a caption display time, and a caption display period contained in the loaded captions.

4. The method as claimed in claim 1, further comprising sending contents containing the encoded captions based on IEEE1394.

5. The method as claimed in claim 1, wherein said retrievable format includes an MPEG2—TS format.

6. A contents retrieval device, comprising:
a caption loading unit that searches for captions corresponding to contents selected for retrieval and loads the searched captions;
a caption parsing unit that parses the loaded captions;
a contents decoding unit that decodes the parsed captions and the contents selected for retrieval; and
a contents encoding unit that encodes contents containing the decoded captions into a retrievable format.

7. The device as claimed in claim 6, wherein the contents decoding unit outputs the parsed caption data to the decoded contents for a caption display period at a corresponding caption display time.

8. The device as claimed in claim 6, wherein the caption parsing unit separates caption data, a caption display time, and a caption display period contained in the loaded captions.

9. The device as claimed in claim 6, further comprising a contents transferring unit for sending contents containing the encoded captions based on IEEE1394.

10. The device as claimed in claim 6, wherein the retrievable format includes an MPEG2—TS format.

11. A contents retrieval device, comprising:
a loading means for loading caption data for contents selected for retrieval;
a parsing means for parsing said caption data;
a decoding means for decoding said contents and outputting said parsed caption data to the decoded contents; and
an encoding means for encoding the decoded contents that contain said parsed caption data.
